(19) United States
(12) Patent Application Publication
(10) Pub. No.: US 2026/0059575 A1
(43) Pub. Date: Feb. 26, 2026

(54) RANDOM ACCESS CHANNEL REPORT ENHANCEMENTS

(71) Applicant: Apple Inc., Cupertino, CA (US)

(72) Inventors: Alexander SIROTKIN, Hod Hasharon (IL); Peng CHENG, Beijing (CN); Ralf ROSSBACH, Munich (DE); Naveen Kumar R. PALLE VENKATA, San Diego, CA (US); Zhibin WU, Los Altos, CA (US); Fangli XU, Beijing (CN); Haijing HU, Los Gatos, CA (US)

(21) Appl. No.: 19/102,839

(22) PCT Filed: Aug. 10, 2022
(86) PCT No.: PCT/CN2022/111408

§ 371 Date: Feb. 10, 2025

(51) Int. Cl. H04W 74/0833; H04W 24/10

(52) U.S. Cl. CPC H04W 74/0833; H04W 24/10

(57) ABSTRACT

Methods and apparatuses are disclosed for random access channel (RACH) report enhancements. In one example embodiment, a user equipment (UE) may be configured to implement operations including: receiving a set of preamble configurations associated with features from a network; selecting a preamble from the set of preamble configurations; and transmitting the selected preamble to initiate random access with the network utilizing RACH partitioning to use a feature.

### FIELD OF INVENTION

This invention relates generally to the field of wireless communication, and more particularly, to methods and apparatuses used in a communication network to implement random access channel (RACH) report enhancements.

### BACKGROUND OF THE INVENTION

In a wireless communications network, a user equipment (UE) may communicate with a base station of the network by establishing a radio link between the UE and the base station. In a 5G (New Radio or NR) or 4G (LTE) wireless network, a UE may receive signaling and data from the serving base station in a downlink transmission direction or transmit signaling and data to the serving base station in an uplink transmission direction.

As part of the 3rd Generation Partnership Project (3GPP), a random access (RA) procedure may be performed for the UE to access the network. In 3GPP, a random access channel (RACH) for the random access (RA) procedure may be used by the UE accessing the network. The RACH, in turn, is mapped to physical RACH (PRACH), which includes preamble resources. Currently, upon successful or unsuccessful completion of the RA procedure, the UE typically logs RA-related information in an RA-report variable. Later, the network may request the UE to send the RA-report by transmitting a UE Information Request to the UE after radio resource control (RRC) connection has been established with the UE. If requested, and there is information available in the RA-report, the UE sends the information to the network by including a RA-report list in a UE information response message. In general, each entry in the RA-report list includes information about specific RA attempts.

As new features are being developed and defined in new releases for 4G, 5G, for the 3GPP, self-organizing networks need to be enhanced to address and troubleshoot these new features. However, new features being developed and defined in new releases for 4G, 5G, etc., such as: random address channel (RACH) partitioning features, slice-based RACH features, small data transmission (SDT) features, reduced capability (RedCap) features, non-terrestrial network (NTN) features, etc., are currently not being efficiently utilized and reported. It should be appreciated that these are just a few of the many new features being introduced by new releases. Although existing protocols describe that the network may transmit system information to the UE indicating that it supports RACH partitioning, there are not suitable methods for the UE to successfully establish an RA connection utilizing RACH partitioning for these new features and to report them.

It would be beneficial to implement a method to allow a UE to provide to the network a report of the features that the UE successfully established in an RA connection utilizing RACH partitioning, very early in the process.

### SUMMARY OF THE DESCRIPTION

Methods and apparatuses are disclosed for use in a communication network to implement random access channel (RACH) report enhancements. In one example embodiment, a user equipment (UE) to connect to a network is described that comprises: at least one antenna; at least one radio, wherein the at least one radio is configured to communicate with the network including a base station using the at least one antenna; and at least one processor coupled to the at least one radio. The at least one processor of the UE is configured to perform operations including: receiving a set of preamble configurations associated with features from the network; selecting a preamble from the set of preamble configurations; and transmitting the selected preamble to initiate random access with the network utilizing random access channel (RACH) partitioning to use a feature. In one embodiment, the preamble configurations for features may be transmitted to the UE in System Information Blocks (SIBs). In one embodiment, the features may include at least one of: reduced capability (RedCap) features, small data transmission (SDT) features, coverage enhancements features, slice grouping features, or non-terrestrial networks (NTN) features. In one embodiment, when the random access to connect to the network is not successful, the feature that the UE requested to use but that was not supported may be logged. In one embodiment, information about the feature the UE requested to be used, but that was not supported, is transmitted in a UE RACH report in a UE information response to the network. In one embodiment, information about the feature the UE requested to be used, but that was not supported, is transmitted in a new predefined information element (IE) created for an existing UE information response to the network.

In another example embodiment, a baseband processor of a wireless user equipment (UE) of a network is disclosed that: receives a set of preamble configurations associated with features from the network; selects a preamble from the set of preamble configurations; and transmits the selected preamble to initiate random access with the network utilizing random access channel (RACH) partitioning to use a feature. In one embodiment, the preamble configurations for features may be transmitted to the UE in System Information Blocks (SIBs). In one embodiment, the features may include at least one of: reduced capability (RedCap) features, small data transmission (SDT) features, coverage enhancements features, slice grouping features, or non-terrestrial networks (NTN) features. In one embodiment, when the random access to connect to the network is not successful, the feature that the UE requested to use but that was not supported may be logged. In one embodiment, information about the feature the UE requested to be used, but that was not supported, is transmitted in a UE RACH report in a UE information response to the network. In one embodiment, information about the feature the UE requested to be used, but that was not supported, is transmitted in a new predefined information element (IE) created for an existing UE information response to the network.

In an additional example embodiment, a base station of a communication network is disclose that comprises: at least one antenna; at least one radio, wherein the at least one radio is configured to communicate with a communication network using the at least one antenna; and at least one processor coupled to the at least one radio. Further, the at least one processor of the base station is configured to perform operations including: transmitting a set of preamble configurations associated with features from the communication network; receiving a selected preamble from a user equipment (UE) initiating random access utilizing random access channel (RACH) partitioning; and when the random access connection is successful, receiving an indication that the UE intends to use the selected feature. In one embodiment, the preamble configurations for features are transmitted to the UE in System Information Blocks (SIBs). Moreover, in one embodiment, the features include at least one of: reduced capability (RedCap) features, small data transmission (SDT) features, coverage enhancements features, slice grouping features, or non-terrestrial networks (NTN) features. In one embodiment, when the random access to connect to the network is not successful, the base station further receives the feature the UE requested to be used but that was not supported to the base station. In one additional embodiment, the feature the UE requested to be used, but that was not supported, is received in a UE RACH report in a UE information response to the base station. In a further embodiment, the information about the feature the UE requested to be used, but that was not supported, is received in a new predefined information element (IE) created for an existing UE information response to the base station.

In another example embodiment, a baseband processor of a base station of a network is disclosed that is configured to perform operations including: transmitting a set of preamble configurations associated with features from the communication network; receiving a selected preamble from a user equipment (UE) initiating random access utilizing random access channel (RACH) partitioning; and when the random access connection is successful, receiving an indication that the UE intends to use the selected feature. In one embodiment, the preamble configurations for features are transmitted to the UE in System Information Blocks (SIBs). Moreover, in one embodiment, the features include at least one of: reduced capability (RedCap) features, small data transmission (SDT) features, coverage enhancements features, slice grouping features, or non-terrestrial networks (NTN) features. In one embodiment, when the random access to connect to the network is not successful, the base station further receives the feature the UE requested to be used but that was not supported to the base station. In one additional embodiment, the feature the UE requested to be used, but that was not supported, is received in a UE RACH report in a UE information response to the base station. In a further embodiment, the information about the feature the UE requested to be used, but that was not supported, is received in a new predefined information element (IE) created for an existing UE information response to the base station.

In yet another additional example embodiment, a method to enable the use of features by a user equipment (UE) in a network is disclosed that includes the operations of: receiving a set of preamble configurations associated with features from the network; selecting a preamble from the set of preamble configurations; and transmitting the selected preamble to initiate random access with the network utilizing random access channel (RACH) partitioning to use a feature. In one embodiment, the preamble configurations for features are transmitted to the UE in System Information Blocks (SIBs). Further, in one embodiment, the features include at least one of: reduced capability (RedCap) features, small data transmission (SDT) features, coverage enhancements features, slice grouping features, or non-terrestrial networks (NTN) features. Additionally, in one embodiment, when the random access to connect to the network is not successful, the feature the UE requested to use but that was not supported is logged. In one embodiment, information about the feature the UE requested to be used, but that was not supported, is transmitted in a UE RACH report in a UE information response to the network. Further, in one embodiment, information about the feature the UE requested to be used, but that was not supported, is transmitted in a new predefined information element (IE) created for an existing UE information response to the network.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6 illustrates a process for a UE to implement RACH report enhancements with a base station in a wireless communication network according to one embodiment of the disclosure.

FIG. 7 illustrates a process for a UE to report features or a Fallback of requested features that were not supported to the base station according to one embodiment of the disclosure.

FIG. 8 illustrates a block diagram of UE logs and reports according to one embodiment of the disclosure.

FIG. 9 is a flow diagram illustrating creating an existing UE RACH report including previously described optional features according to one embodiment of the disclosure.

FIG. 10 is a flow diagram illustrating creating a new UE RACH report according to one embodiment of the disclosure.

### DETAILED DESCRIPTION

Methods and apparatuses are disclosed for use in a communication network to implement random access channel (RACH) report enhancements. In one example embodiment, a user equipment (UE) may be configured to implement operations including: receiving a set of preamble configurations associated with features from a network; selecting a preamble from the set of preamble configurations; and transmitting the selected preamble to initiate random access (RA) with the network utilizing RACH partitioning to use a feature. Further, in one example embodiment, a method to allow a UE to provide to the communication network a report of the features that the UE successfully established in an RA connection utilizing RACH partitioning, very early in the process, is disclosed, as well reporting features that were attempted, but that were not implemented by the network.

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

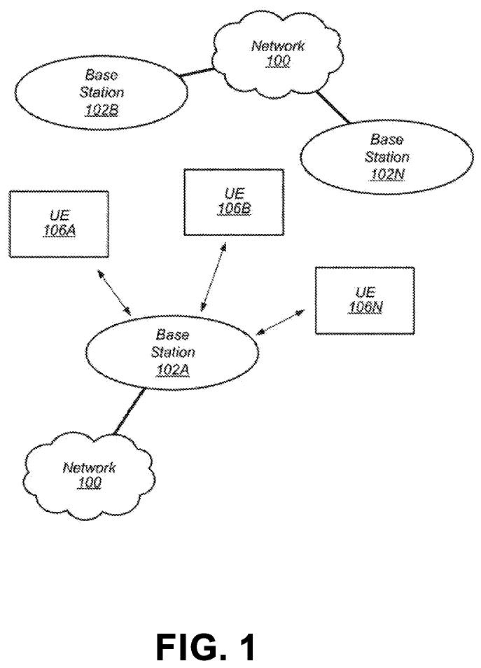

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

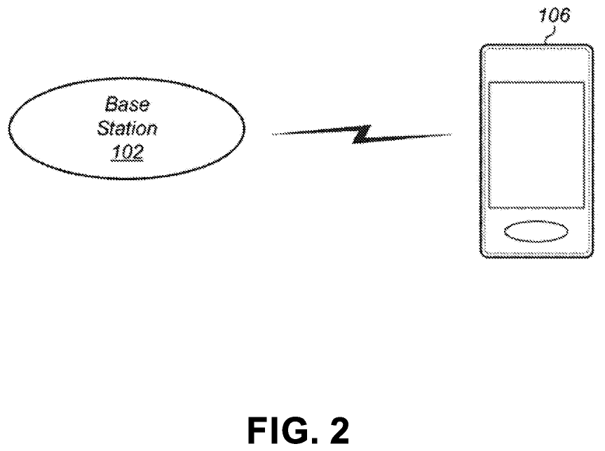

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

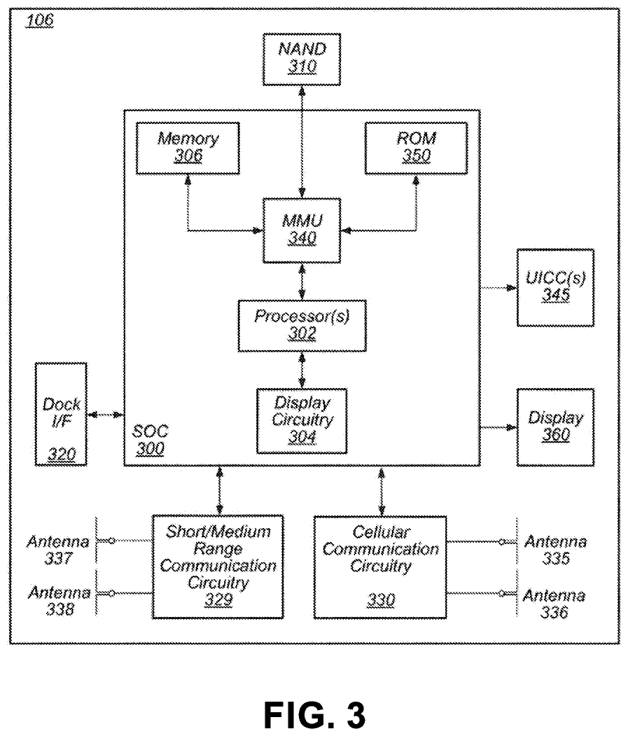

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

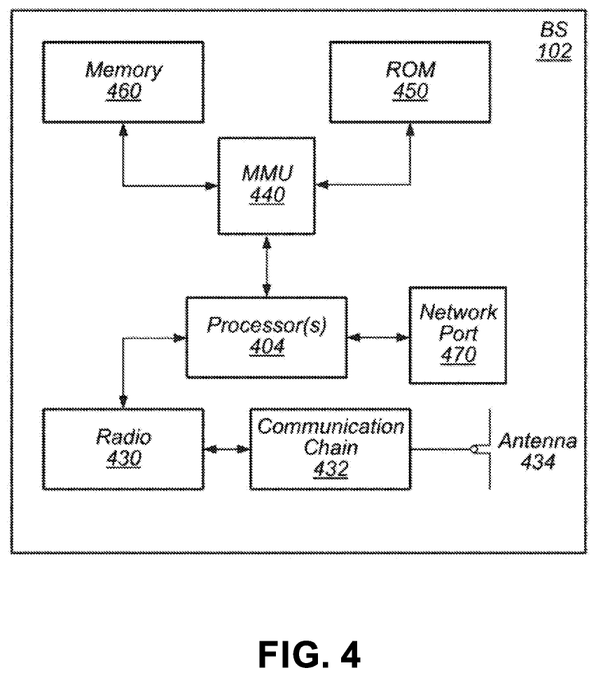

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

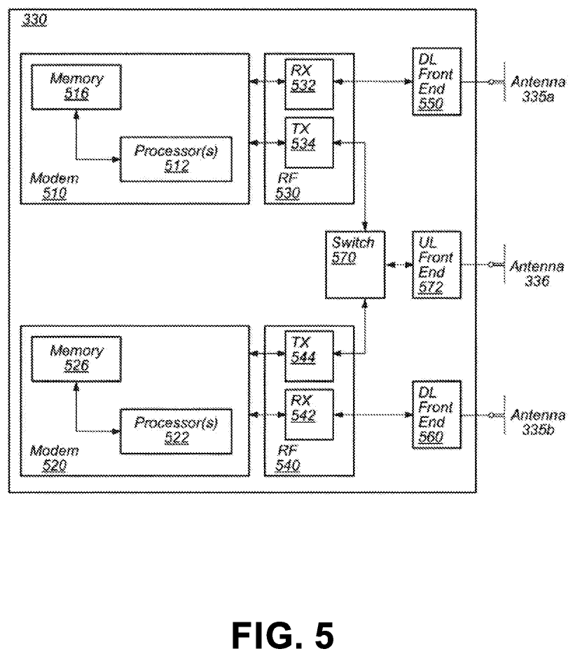

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

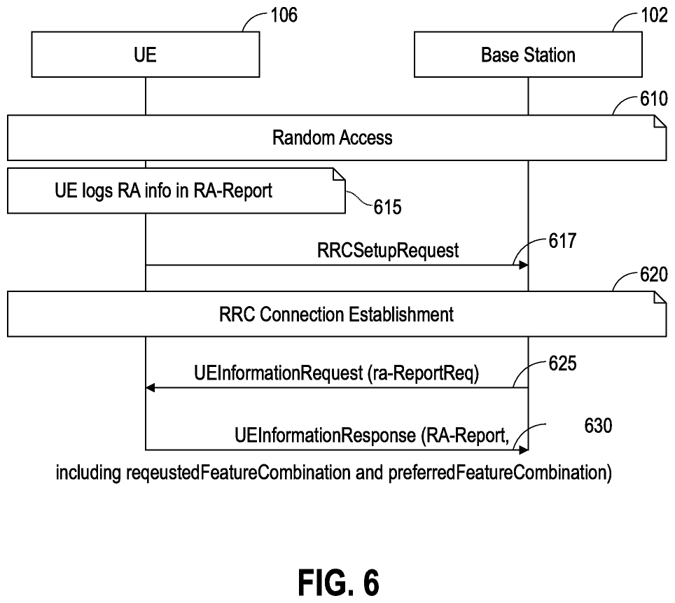

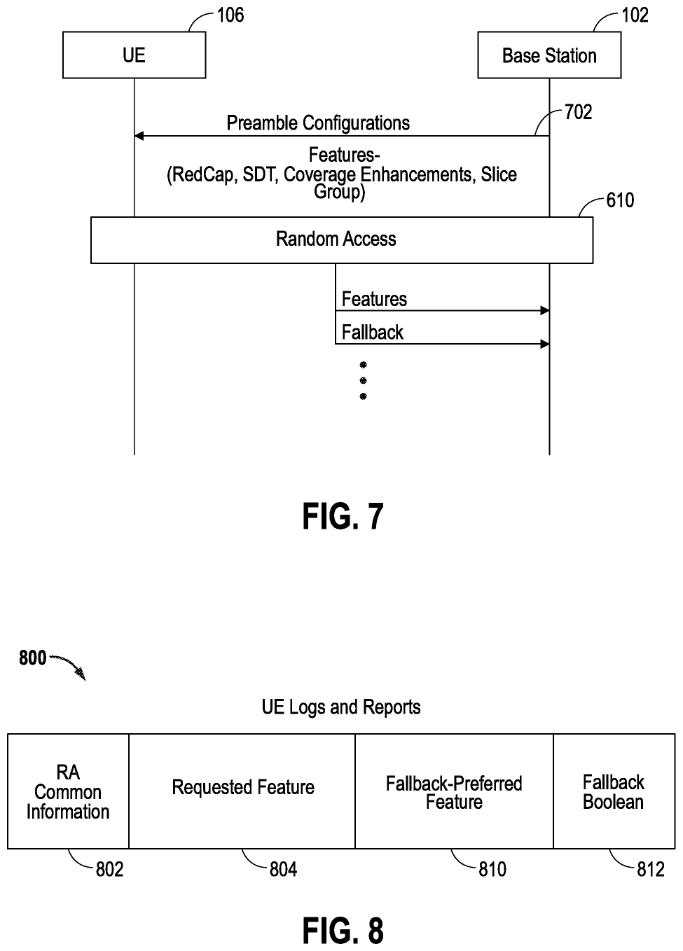

FIG. 6 illustrates a process for UE 106 to implement random access channel (RACH) report enhancements with base station 102 in a wireless communication network. FIG. 7 illustrates a process for UE 106 to report features or a Fallback of requested features that were not supported to base station 102. In the following description, the terms “base station” and “network” may be used interchangeably.

With reference to FIGS. 6 and 7, in one example embodiment, user equipment (UE) 106 to connect to a network through base station 102 is described. As previously described, UE 106 comprises: at least one antenna; at least one radio, wherein the at least one radio is configured to communicate with the network including the base station 102 using the at least one antenna; and at least one processor coupled to the at least one radio. The at least one processor of UE 106 is configured to perform operations including: receiving a set of preamble configurations 702 associated with features from the base station 102; selecting a preamble from the set of preamble configurations; and transmitting the selected preamble to initiate random access (RA) 610 with the base station 102 utilizing RACH partitioning to use a feature.

Further, as will be described, UE 106 provides to the base station 102 a report of the features that UE 106 successfully established in the RA connection 610 utilizing RACH partitioning, as well reporting features that were attempted, but that were not implemented by the network (Fallback), very early in the process. These features may reported in a UE information response 630, as will be described.

In one example embodiment, as part of 3GPP, a random access (RA) 610 procedure may be performed for the UE 106 to access the network through the base station 102. In 3GPP, a random access channel (RACH) for the random access (RA) procedure may be used by the UE accessing the network. In this example embodiment, as part of RA 610, UE 106 receives a set of preamble configurations 702 associated with features from the base station 102 and selects a preamble from the set of preamble configurations, and transmits the selected preamble to initiate random access (RA) 610 with the base station 102 utilizing RACH partitioning to use a feature. It should be appreciated that by using feature preamble information elements (IEs), the base station 102 may assign RACH resources to a specific feature or a features combination. UE 106 initiating RA when it intends to use the connection for one of the features or feature combinations signaled by the base station 102 in the feature preamble IEs may use RACH resources associated with that feature or feature combination. Therefore, the network may configure the UE 106 for initial connection setup including resource configuration for the random access channel (RACH) process.

In one particular embodiment, the preamble configurations may be related to new feature resources (e.g., developed in 4G, 5G, etc.) and may include preamble configurations designating new feature resources including at least one of: reduced capability (RedCap) features, small data transmission (SDT) features, coverage enhancements features (e.g., msg3 repetitions), slice grouping features (e.g., Network Slice AS group (NSAG)), or non-terrestrial network (NTN) features. It should be appreciated that these are just example features and that any RACH feature resource may be implemented that may be put in a preamble configuration. In one embodiment, the preamble configurations 702 for feature resources may be transmitted to UE 106 in System Information Blocks (SIBs). Additionally, the network through base station 102 may transmit system information to the UE 106 indicating that it supports RACH partitioning and the network may use feature combination preambles information elements (IEs) to assign RACH resources to specific features or feature combinations. UE 106 may utilize these resources associated with a feature or a combination of features in the RA 610 procedure.

Upon successful or unsuccessful completion of the RA procedure 610, UE 106 logs RA-related information in an RA-report variable 615. A radio resource control (RRC) set up request 617 may be transmitted from the UE 106 to the base station 102. An RRC connection 620 may be established between UE 106 and base station 102. An indication about RA-related report information availability may be sent as part of the RRC connection establishment procedure 620. In particular, the RRC connection establishment procedure 620 may include three messages: RRCSetupRequest (UE to network), RRCSetup (network to UE), and RRCSetupComplete (UE to network). The RRCSetupComplete message carries the availability indication. In other examples, an availability indication may also be sent in RRCReestablishmentComplete, RRCResumeComplete and RRCReconfigurationComplete messages. Later, base station 102 may request UE 106 to send an RA-report by transmitting a UE Information Request 625 to UE 106 after the radio resource control (RRC) connection 620 has been established with UE 106. If requested, and there is information available in the RA-report, UE 106 sends the information to base station 102 by including a RA-report in a UE information response message 630. In general, each entry in the RA-report list includes common information about the RA attempts and a per RA information list about specific RA attempts.

As has been described, as new features are being developed and defined in new releases for 4G, 5G, etc., self-organizing networks need to be enhanced to address and troubleshoot these new features. However, new features being developed and defined in new releases for 4G, 5G, etc., such as: reduced capability (RedCap) features, small data transmission (SDT) features, coverage enhancements features (e.g., msg3 repetitions), slice grouping features (e.g., Network Slice AS group (NSAG)), or non-terrestrial network (NTN) features, are currently not being efficiently utilized and reported.

In one embodiment, UE 106 in the UE information response 630 to the base station 102 and network, not only reports RA common information but also reports both requested features or feature combinations that UE 106 used in RA 610, successfully, or enhanced feature or feature combinations that UE 106 requested in RA 610, but that was not successful.

With brief additional reference to FIG. 8, FIG. 8 illustrates a block diagram 800 of UE logs and reports. As shown, UE 106 logs and reports: RA common information 802, requested feature or feature combinations 804, Fallback-preferred feature or feature combinations 810. A Fallback Boolean 812 may also be utilized to indicate Fallback occurred. Therefore, UE 106 reports to the base station 102, in requested feature 804, the feature or feature combinations that UE 106 used in the RA 610, successfully. Further, UE 106 reports in Fallback preferred feature 810, features or feature combinations that UE 106 requested in the RA 610, but that was not successful. It should be appreciated that the features or feature combinations refer to new features, as previously described. It should be appreciated that this can be logged and reported per RA report or per RA attempt. The UE should only log and report these additional features if requested by the network.

Therefore, as previously described, in one embodiment, UE information response 630 including RA common information element (IE) 802 can be extended with additional elements. For example, a requested feature information element (IE) 804 can be added. Requested feature information element (IE) 804 is added to indicate which feature or combination of features triggered the RA 610. Such new features or combinations of features may include: reduced capability (RedCap) features, small data transmission (SDT) features, coverage enhancements features (e.g., msg3 repetitions), slice grouping features (e.g., Network Slice AS group (NSAG)), or non-terrestrial network (NTN) features. It should be appreciated that these are just example features. Of course, as new features are added, the same procedures will be implemented to include the new features. Further, the Fallback preferred feature information element (IE) 810 may be added to indicate which feature or combination of features the UE requested to use, but that was unsuccessful. Moreover, as previously described, a Fallback Boolean information element (IE) 812 may be added to indicate that Fallback has occurred.

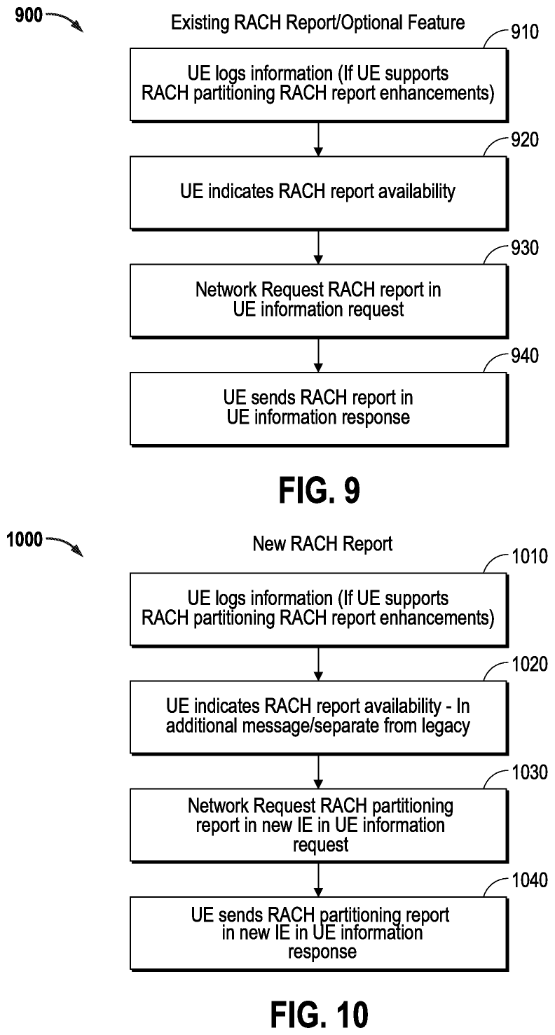

FIG. 9 is a flow diagram illustrating creating an existing UE RACH report including the previously described optional features, according to one embodiment of the disclosure. In one embodiment, the new enhancements previously described may be an optional feature that is part of the existing RACH report (e.g., UE information response 630). As has been described, if UE 106 supports RACH partitioning and RACH report enhancements, UE 106 logs the information described above (e.g., FIG. 8) (block 910). UE 106 also indicates RACH report availability (block 920). Further, base station 102 requests a RACH report in a UE information request (e.g., UE information request 625) (block 930). Based upon this, UE 106 send a RACH report (including the new information, if logged) in a RA report list information element (IE) included in a UE information response (e.g., UE information response 630) with the new information described above (e.g., FIG. 8) (block 940).

FIG. 10 is a flow diagram illustrating creating a new UE RACH report. In one embodiment, the new RACH report for RACH partitioning is defined as separate report. As has been described, if UE 106 supports RACH partitioning and RACH report enhancements, UE 106 logs the information described above (e.g., FIG. 8) (block 1010). UE 106 also indicates RACH report availability separately from legacy RACH report availability (block 1020). Further, base station 102 requests a RACH partitioning report in a newly defined information element (IE) in a UE information request (block 1030). Based upon this, UE 106 sends a RACH partitioning report in a newly defined information element (IE) included in a UE information response with the new information described above (e.g., FIG. 8) (block 1040). It should be appreciated that reporting options for the UE previously described, may be optional. One way to define such capability may to add a new parameter to the SON-Parameters IE (which is included in UE-NR-Capability IE). Alternatively, a RACH partition reporting capability parameter can be added separately, e.g., included directly in UE-NR-Capability IE.

In an additional example embodiment, the features previously described, can be illustrated from the perspective of base station 102. As previously described, base station 102 of a communication network is disclosed that comprises: at least one antenna; at least one radio, wherein the at least one radio is configured to communicate with a communication network using the at least one antenna; and at least one processor coupled to the at least one radio.

With reference to FIGS. 6 and 7, the at least one processor of the base station 102 is configured to perform operations including: transmitting a set of preamble configurations 702 associated with features from the communication network; receiving a selected preamble from the UE 106 initiating random access 610 utilizing random access channel (RACH) partitioning; and when the random access connection is successful, receiving an indication that the UE intends to use the selected feature. In one embodiment, the preamble configurations 702 for features are transmitted to the UE in System Information Blocks (SIBs). Moreover, in one embodiment, the features include at least one of: reduced capability (RedCap) features, small data transmission (SDT) features, coverage enhancements features, slice grouping features, or non-terrestrial networks (NTN) features.

As has been previously described, in one embodiment, UE 106 provides to the base station 102 a report of the features that UE 106 successfully established in the RA connection 610 utilizing RACH partitioning, as well as reporting features that were attempted, but that were not implemented by the network (Fallback), very early in the process. These features may reported in a UE information response 630. In one embodiment, UE 106 in the UE information response 630 to the base station 102 and network, not only reports RA common information but also reports both requested features or feature combinations that UE 106 used in the RA 610, successfully, or enhanced feature or feature combinations that UE 106 requested in RA 610, but that were not successful. These enhanced reporting features were previously described in detail with references to FIGS. 8-10.

Baseband processors of the UE and base station have been previously described. It should also be appreciated that the baseband processor of the UE and the baseband processor of the base station may implement the previously described functions.

As has been described, as new features are being developed and defined in new releases for 4G, 5G, etc., self-organizing networks need to be enhanced to address and troubleshoot these new features. However, new features being developed and defined in new releases for 4G, 5G, etc., such as: random address channel (RACH) partitioning features, slice-based RACH features, small data transmission (SDT) features, reduced capability (RedCap) features, non-terrestrial network (NTN) features, etc., are currently not being efficiently utilized and reported by prior art implementations.

As has been previously described, the features of the previously described embodiments, allow a UE to provide to the base station and network a report of the features that the UE successfully established in an RA connection utilizing RACH partitioning, very early in the process. In particular, the previously described embodiments, describe that a UE can successfully establish an RA connection utilizing RACH partitioning for these new features and to report them, early in the process. It should also be noted because the amount of RACH resources for these new features are limited, it is important for the network to assign RACH resources to features that are to be used, early in the process. This helps the network properly allocate resources and handle connections and data usage in the most efficient way. Further, the previously described embodiments, not only describe reporting new features that are successfully accessed, but also reporting new features that are not successfully accessed.

Also, the previously described embodiments may be utilized to enhance network behavior. As previously described, the network may collect RACH reports for RACH partitioning from multiple UEs over time, before making changes to its configuration (i.e., assignment of RACH resources for features and feature combinations). This includes both successfully accessed features and features that were requested—but not successfully accessed. The network can utilize this collected data to update its assignment of RACH resources for features and feature combinations. For example, if certain features and feature combinations are rarely requested, the network may remove them from RACH partitioning. On the other hand, if certain features or feature combinations do not have dedicated RACH resources and they are being indicated as a preferred by a sufficiently large number of UEs, the network may assign dedicated RACH resources to such feature and feature combinations. This process may occur at the base station (gNB) itself or in a centralized entity, e.g., a SON server.

As has been described, methods and apparatuses are disclosed for use in a communication network to implement random access channel (RACH) report enhancements. In one example embodiment, a user equipment (UE) to connect to a network is described that comprises: at least one antenna; at least one radio, wherein the at least one radio is configured to communicate with the network including a base station using the at least one antenna; and at least one processor coupled to the at least one radio. The at least one processor of the UE is configured to perform operations including: receiving a set of preamble configurations associated with features from the network; selecting a preamble from the set of preamble configurations; and transmitting the selected preamble to initiate random access with the network utilizing random access channel (RACH) partitioning to use a feature. In one embodiment, the preamble configurations for features may be transmitted to the UE in System Information Blocks (SIBs). In one embodiment, the features may include at least one of: reduced capability (RedCap) features, small data transmission (SDT) features, coverage enhancements features, slice grouping features, or non-terrestrial networks (NTN) features. In one embodiment, when the random access to connect to the network is not successful, the feature that the UE requested to use but that was not supported may be logged. In one embodiment, information about the feature the UE requested to be used, but that was not supported, is transmitted in a UE RACH report in a UE information response to the network. In one embodiment, information about the feature the UE requested to be used, but that was not supported, is transmitted in a new predefined information element (IE) created for an existing UE information response to the network.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the described operations may be stored as instructions on a non-transitory computer readable medium for execution by a computer. The computer may execute the instructions to: receive a set of preamble configurations associated with features from the network; select a preamble from the set of preamble configurations; and transmit the selected preamble to initiate random access with the network utilizing random access channel (RACH) partitioning to use a feature.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A user equipment (UE) to connect to a network comprising:
at least one antenna;
at least one radio, wherein the at least one radio is configured to communicate with the network including a base station using the at least one antenna; and
at least one processor coupled to the at least one radio, wherein the at least one processor is configured to perform operations comprising:
receiving a set of preamble configurations associated with features from the network;
selecting a preamble from the set of preamble configurations; and
transmitting the selected preamble to initiate random access with the network utilizing random access channel (RACH) partitioning to use a feature.

2. The UE of claim 1, wherein the preamble configurations for features are transmitted to the UE in System Information Blocks (SIBs).

3. The UE of claim 3, wherein the features include at least one of: reduced capability (RedCap) features, small data transmission (SDT) features, coverage enhancements features, slice grouping features, or non-terrestrial networks (NTN) features.

4. The UE of claim 1, wherein, when the random access to connect to the network is not successful, further comprising: logging the feature the UE requested to use but that was not supported.

5. The UE of claim 4, wherein, information about the feature the UE requested to be used, but that was not supported, is transmitted in a UE RACH report in a UE information response to the network.

6. The UE of claim 4, wherein, information about the feature the UE requested to be used, but that was not supported, is transmitted in a new predefined information element (IE) created for an existing UE information response to the network.

7. A baseband processor of a wireless user equipment (UE) of a network comprising:
receiving a set of preamble configurations associated with features from the network;
selecting a preamble from the set of preamble configurations; and
transmitting the selected preamble to initiate random access with the network utilizing random access channel (RACH) partitioning to use a feature.

8. The baseband processor of claim 7, wherein the preamble configurations for features are transmitted to the UE in System Information Blocks (SIBs).

9. The baseband processor of claim 8, wherein the features include at least one of: reduced capability (RedCap) features, small data transmission (SDT) features, coverage enhancements features, slice grouping features, or non-terrestrial networks (NTN) features.

10. The baseband processor of claim 7, wherein, when the random access to connect to the network is not successful, further comprising: logging the feature the UE requested to use but that was not supported.

11. The baseband processor of claim 10, wherein, information about the feature the UE requested to be used, but that was not supported, is transmitted in a UE RACH report in a UE information response to the network.

12. The baseband processor of claim 10, wherein, information about the feature the UE requested to be used, but that was not supported, is transmitted in a new predefined information element (IE) created for an existing UE information response to the network.

13. A base station of a communication network, comprising:
at least one antenna;
at least one radio, wherein the at least one radio is configured to communicate with a communication network using the at least one antenna; and
at least one processor coupled to the at least one radio, wherein the at least one processor is configured to perform operations comprising:
transmitting a set of preamble configurations associated with features from the communication network;
receiving a selected preamble from a user equipment (UE) initiating random access utilizing random access channel (RACH) partitioning; and
when the random access connection is successful, receiving an indication that the UE intends to use the selected feature.

14. The base station of claim 13, wherein the preamble configurations for features are transmitted to the UE in System Information Blocks (SIBs).

15. The base station of claim 14, wherein the features include at least one of: reduced capability (RedCap) features, small data transmission (SDT) features, coverage enhancements features, slice grouping features, or non-terrestrial networks (NTN) features.

16. The base station of claim 13, wherein, when the random access to connect to the network is not successful, further comprising: receiving the feature the UE requested to be used but that was not supported to the base station.

17. The base station of claim 16, wherein, the feature the UE requested to be used, but that was not supported, is received in a UE RACH report in a UE information response to the base station.

18. The base station of claim 16, wherein, information about the feature the UE requested to be used, but that was not supported, is received in a new predefined information element (IE) created for an existing UE information response to the base station.

19. A baseband processor of a base station of a network configured to perform operations comprising:
transmitting a set of preamble configurations associated with features from the communication network;
receiving a selected preamble from a user equipment (UE) initiating random access utilizing random access channel (RACH) partitioning; and
when the random access connection is successful, receiving an indication that the UE intends to use the selected feature.

20. The baseband processor of claim 19, wherein the preamble configurations for features are transmitted to the UE in System Information Blocks (SIBs).

21. The baseband processor of claim 20, wherein the features include at least one of: reduced capability (RedCap) features, small data transmission (SDT) features, coverage enhancements features, slice grouping features, or non-terrestrial networks (NTN) features.

22. The baseband processor of claim 19, wherein, when the random access to connect to the network is not successful, further comprising: receiving the feature the UE requested to be used but that was not supported to the base station.

23. The baseband processor of claim 22, wherein, the feature the UE requested to be used, but that was not supported, is received in a UE RACH report in a UE information response to the base station.

24. The baseband processor of claim 22, wherein, information about the feature the UE requested to be used, but that was not supported, is received in a new predefined information element (IE) created for an existing UE information response to the base station.

25. A method to enable the use of features by a user equipment (UE) in a network comprising:
receiving a set of preamble configurations associated with features from the network;
selecting a preamble from the set of preamble configurations; and
transmitting the selected preamble to initiate random access with the network utilizing random access channel (RACH) partitioning to use a feature.

26. The method of claim 25, wherein the preamble configurations for features are transmitted to the UE in System Information Blocks (SIBs).

27. The method of claim 26, wherein the features include at least one of: reduced capability (RedCap) features, small data transmission (SDT) features, coverage enhancements features, slice grouping features, or non-terrestrial networks (NTN) features.

28. The method of claim 25, wherein, when the random access to connect to the network is not successful, further comprising: logging the feature the UE requested to use but that was not supported.

29. The method of claim 28, wherein, information about the feature the UE requested to be used, but that was not supported, is transmitted in a UE RACH report in a UE information response to the network.

30. The method of claim 28, wherein, information about the feature the UE requested to be used, but that was not supported, is transmitted in a new predefined information element (IE) created for an existing UE information response to the network.
